(19) United States
(12) Patent Application Publication
(10) Pub. No.: US 2022/0134939 A1
(43) Pub. Date: May 5, 2022

(54) VEHICULAR LAMP AND VEHICLE

(71) Applicant: KOITO MANUFACTURING CO., LTD., Tokyo (JP)

(72) Inventors: Yuta Maruyama, Shizuoka (JP); Kosei Kikuchi, Shizuoka (JP)

(73) Assignee: KOITO MANUFACTURING CO., LTD., Tokyo (JP)

(21) Appl. No.: 17/436,415

(22) PCT Filed: Feb. 19, 2020
(86) PCT No.: PCT/JP2020/006472

§ 371 Date: Sep. 3, 2021

(30) Foreign Application Priority Data
Mar. 6, 2019 (JP) 2019-040703
Mar. 6, 2019 (JP) 2019-040704
Feb. 13, 2020 (JP) 2019-022494

(51) Int. Cl. B60Q 1/00; G01S 13/931; G01S 7/02

(52) U.S. Cl. CPC B60Q 1/0023; G01S 13/931; G01S 2013/93277; G01S 2013/93271; G01S 7/027

(57) ABSTRACT

A front left lamp includes a housing, an outer cover covering an opening of the housing, and a millimeter-wave radar. The millimeter-wave radar includes an antenna unit and a communication circuit unit. The antenna unit includes a transmitting antenna and a receiving antenna. The communication circuit unit includes a transmission side RF circuit electrically connected to the transmitting antenna, a reception side RF circuit electrically connected to the receiving antenna, and a signal processing circuit configured to process a digital signal output from the reception side RF circuit. The antenna unit is provided inside the outer cover. The communication circuit unit is disposed in a space formed by the housing and the outer cover.

### TECHNICAL FIELD

The present disclosure relates to a vehicular lamp and a vehicle.

### BACKGROUND ART

Currently, research on automatic driving technology for an automobile is being actively conducted in each country and legislation is being considered in each country to allow a vehicle (hereinafter, “vehicle” refers to an automobile) to drive on a public road in an automatic driving mode. Here, in the automatic driving mode, a vehicle system automatically controls traveling of a vehicle. Specifically, in the automatic driving mode, the vehicle system automatically performs at least one of steering control (control of a vehicle's traveling direction), brake control and accelerator control (vehicle braking, acceleration and deceleration control) based on information (surrounding environment information) indicating surrounding environment of the vehicle obtained from sensors such as a camera and a radar (for example, a laser radar and a millimeter-wave radar). On the other hand, in a manual driving mode described below, a driver controls traveling of a vehicle, as is the case with many conventional vehicles. Specifically, in the manual driving mode, the traveling of the vehicle is controlled according to the driver's operation (steering operation, brake operation, accelerator operation) and the vehicle system does not automatically perform steering control, brake control, and accelerator control. The driving mode of a vehicle is not a concept which exists only in some vehicles, but a concept which exists in all vehicles including conventional vehicles which do not have an automatic driving function. Further, the driving mode of a vehicle is classified according to, for example, a vehicle control method or the like.

Thus, in the future, on a public road, it is expected that vehicles (hereinafter, appropriately referred to as “automatic driving vehicle”) traveling in the automatic driving mode and vehicles (hereinafter, appropriately referred to as “manual driving vehicles”) traveling in the manual driving mode will coexist.

As an example of the automatic driving technology, Patent Literature 1 discloses an automatic following traveling system in which a following vehicle automatically follows a preceding vehicle. In the automatic following traveling system, each of the preceding vehicle and the following vehicle is equipped with a lighting system, and textual information is displayed on the lighting system of the preceding vehicle to prevent other vehicles from interrupting between the preceding vehicle and the following vehicle and textual information indicating that the vehicle is automatically following is displayed on the lighting system of the following vehicle.

### CITATION LIST

### Patent Literature

Patent Literature 1: JP-A-H09-277887

### SUMMARY OF INVENTION

### Technical Problem

By the way, with the development of automatic driving technology, it is necessary to dramatically increase detection accuracy of surrounding environment of a vehicle. In this respect, by mounting a plurality of sensors (for example, camera, LiDAR unit, millimeter-wave radar, and the like) which detect the surrounding environment of a vehicle on the vehicle, it is possible to dramatically improve the detection accuracy of the surrounding environment of the vehicle. In addition, from a viewpoint of appearance of the vehicle and a space for mounting the sensors, it is currently under consideration to mount the plurality of sensors in each vehicular lamp.

However, there are various problems in mounting a plurality of sensors in the vehicular lamp from a viewpoint of design restrictions of the vehicle and the vehicular lamp. For example, depending on the design of the vehicle and the vehicular lamp, there is a problem that the millimeter-wave radar (an example of the radio wave transmission and reception module), which is one of the sensors, cannot be successfully mounted in the vehicular lamp. In order to meet this problem, it is conceivable to reduce an external size of the millimeter-wave radar. However, with the miniaturization (particularly, the miniaturization of an antenna unit of the millimeter-wave radar) of the millimeter-wave radar, detection performance of the millimeter-wave radar may deteriorate. In this way, there is room for studying a method for successfully mounting the radio wave transmission and reception module on the vehicular lamp without downsizing the radio wave transmission and reception module such as the millimeter-wave radar.

It is an object of the present disclosure to successfully mount a radio wave transmission and reception module on a vehicular lamp without reducing an external size of the antenna unit and/or the communication circuit unit of the radio wave transmission and reception module.

### Solution to Problem

A vehicular lamp according to an aspect of the present disclosure includes a housing, an outer cover covering an opening of the housing, and a radio wave transmission and reception module.

The radio wave transmission and reception module includes:
an antenna unit including a transmitting antenna and a receiving antenna; and
a communication circuit unit including,
   a transmission side RF circuit electrically connected to the transmitting antenna,
   a reception side RF circuit electrically connected to the receiving antenna, and
   a signal processing circuit configured to process a digital signal output from the reception side RF circuit.

The antenna unit is provided on the outer cover. The communication circuit unit is disposed in a space formed by the housing and the outer cover.

According to the configuration describe above, while the antenna unit is provided on the outer cover, the communication circuit unit is disposed in the space formed by the housing and the outer cover. Therefore, the radio wave transmission and reception module can be successfully mounted on the vehicular lamp without reducing an external size of the antenna unit and/or the communication circuit unit of the radio wave transmission and reception module.

The antenna unit may be provided inside the outer cover.

According to the configuration described above, the antenna unit is provided inside the outer cover. Therefore, the radio wave transmission and reception module can be successfully mounted on the vehicular lamp without reducing the external size of the antenna unit and/or the communication circuit unit of the radio wave transmission and reception module.

The antenna unit may be provided on a surface of the outer cover.

According to the configuration described above, the antenna unit is provided on the surface of the outer cover. Therefore, the radio wave transmission and reception module can be successfully mounted on the vehicular lamp without reducing the external size of the antenna unit and/or the communication circuit unit of the radio wave transmission and reception module.

The antenna unit and the communication circuit unit may be electrically connected to each other via a metal fixing member which fixes the outer cover and the housing.

According to the configuration described above, the antenna unit and the communication circuit unit can be electrically connected by using the metal fixing member which fixes the outer cover and the housing.

The radio wave transmission and reception module may be a millimeter-wave radar configured to acquire data indicating surrounding environment of a vehicle.

According to the configuration described above, the millimeter-wave radar can be successfully mounted on the vehicular lamp without reducing the external size of the antenna unit and/or the communication circuit unit of the millimeter-wave radar.

The radio wave transmission and reception module may be a wireless communication module configured to wirelessly communicate with an external device.

According to the configuration described above, the wireless communication module can be successfully mounted on the vehicular lamp without reducing the antenna unit and/or the external size of the wireless communication module.

A vehicle including the vehicular lamp described above may be provided.

According to the above, the radio wave transmission and reception module can be successfully mounted on the vehicular lamp without reducing the external size of the antenna unit and/or the communication circuit of the radio wave transmission and reception module.

A vehicular lamp according to another aspect of the present disclosure is mounted on a vehicle and includes:
a housing;
an outer cover covering an opening of the housing;
a lighting unit disposed in a space formed by the housing and the outer cover; and
a millimeter-wave radar configured to acquire data indicating surrounding environment of the vehicle.

The millimeter-wave radar includes:
an antenna unit including a transmitting antenna and a receiving antenna; and
a communication circuit unit including,
   a transmission side RF circuit electrically connected to the transmitting antenna,
   a reception side RF circuit electrically connected to the receiving antenna, and
   a signal processing circuit configured to process a digital signal output from the reception side RF circuit.

The antenna unit and the communication circuit unit are physically separated from each other.

The antenna unit is disposed in the space.

According to the configuration described above, the antenna unit and the communication circuit unit of the millimeter-wave radar are separated from each other. Therefore, the millimeter-wave radar can be successfully mounted on the vehicular lamp without downsizing the millimeter-wave radar.

The vehicular lamp may further include a partition member configured to partition the space into a first space and a second space. The antenna unit and the lighting unit may be disposed in the first space. The communication circuit unit may be disposed in the second space.

According to the configuration described above, the antenna unit and the lighting unit are disposed in the first space, while the communication circuit unit is disposed in the second space. Therefore, it is possible to preferably prevent the communication circuit unit from being adversely affected by heat generated from the lighting unit.

The housing may have an opening portion and a lid portion configured to close the opening portion. The communication circuit unit may be disposed on the lid portion

According to the configuration described above, since the communication circuit unit is disposed on the lid portion of the housing, the communication circuit unit can be easily taken out from the vehicular lamp. Therefore, when there is an abnormality in the communication circuit unit, the communication circuit unit can be quickly taken out from the vehicular lamp, which improves the handleability of the millimeter-wave radar mounted on the vehicular lamp.

The communication circuit unit may be disposed outside the space.

According to the configuration described above, since the communication circuit unit is disposed outside the space, it is possible to preferably prevent the communication circuit unit from being adversely affected by the heat generated from the lighting unit.

The antenna unit may be attached to the outer cover.

According to the configuration described above, since the antenna unit is attached to the outer cover, it is not necessary to secure a space in the lamp for disposing the antenna unit. In this way, the degree of freedom in designing the vehicular lamp can be improved and the millimeter-wave radar can be successfully mounted in the vehicular lamp without downsizing the millimeter-wave radar.

The antenna unit may be transparent to visible light.

According to the configuration described above, since the antenna unit is transparent to visible light, it becomes difficult for the antenna unit to be visually recognized from the outside of the vehicle. In this way, the design properties of the vehicular lamp on which the millimeter-wave radar is mounted can be improved.

A vehicle including the vehicular lamp described above may be provided.

According to the above, the millimeter-wave radar can be successfully mounted on the vehicular lamp without downsizing the millimeter-wave radar.

### Advantageous Effects of Invention

According to the present disclosure, the radio wave transmission and reception module can be successfully mounted on the vehicular lamp without reducing the external size of the antenna unit and/or the communication circuit unit of the radio wave transmission and reception module.

### BRIEF DESCRIPTION OF DRAWINGS

FIG. 1 illustrates a schematic view of a vehicle including a vehicle system according to a first embodiment of the invention.

FIG. 2 is a block diagram illustrating a vehicle system according to the first embodiment.

FIG. 3 is a block diagram illustrating a front left sensing system.

FIG. 4 is a block diagram illustrating a configuration of a millimeter-wave radar.

FIG. 5 is a diagram illustrating a configuration of a transmitting side RF circuit and a receiving side RF circuit.

FIG. 6A is a front view of an antenna unit including a transmitting antenna and a receiving antenna and FIG. 6B is a cross-sectional view taken along the line A-A of the antenna unit illustrated in FIG. 6A.

FIG. 7 is a vertical cross-sectional view illustrating a front left lamp on which the millimeter-wave radar is mounted.

FIG. 8A is a diagram illustrating the antenna unit disposed inside an outer cover, FIG. 8B is a diagram illustrating the antenna unit disposed on an outer surface of the outer cover, FIG. 8C is a diagram illustrating the antenna unit disposed on an inner surface of the outer cover, and FIG. 8D is a diagram illustrating the antenna unit according to a modification example disposed inside the outer cover.

FIG. 9 is a vertical cross-sectional view illustrating a front left lamp according to a second embodiment on which a millimeter-wave radar is mounted.

FIG. 10 is a vertical cross-sectional view illustrating a front left lamp according to a first modification example on which a millimeter-wave radar is mounted.

FIG. 11 is a vertical cross-sectional view illustrating a front left lamp according to a second modification example on which a millimeter-wave radar is mounted.

### DESCRIPTION OF EMBODIMENTS

### First Embodiment

Hereinafter, a first embodiment (hereinafter, simply referred to as “the embodiments”) of the present disclosure will be described with reference to the drawings. For convenience of explanation, description of a member having the same reference numerals as those of a member already described in the description of the embodiment will be omitted. In addition, dimensions of each member illustrated in the drawing may differ from actual dimensions of each member for convenience of explanation.

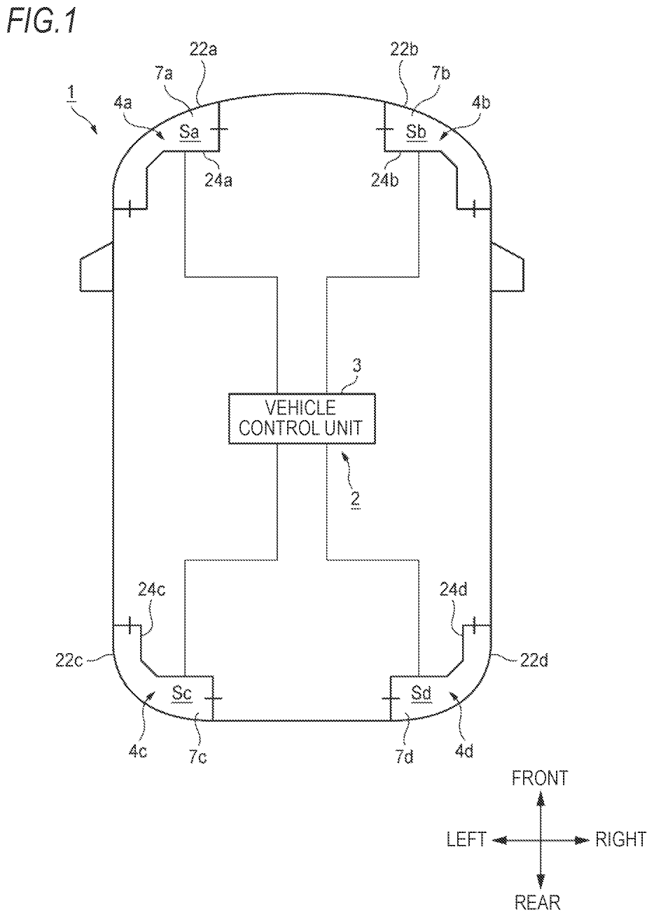

Further, in the description of the embodiment, for convenience of explanation, “left-right direction, “front-rear direction”, and “up-down direction” may be appropriately referred to. These directions are relative directions set for a vehicle 1 illustrated in FIG. 1. Here, the “front-rear direction” is a direction including a “forward direction” and a “rear direction”. The “left-right direction” is a direction including a “left direction” and a “right direction”. The “up-down direction” is a direction including an “upward direction” and a “downward direction”. Although the up-down direction is not illustrated in FIG. 1, the up-down direction is a direction perpendicular to the front-rear direction and the left-right direction.

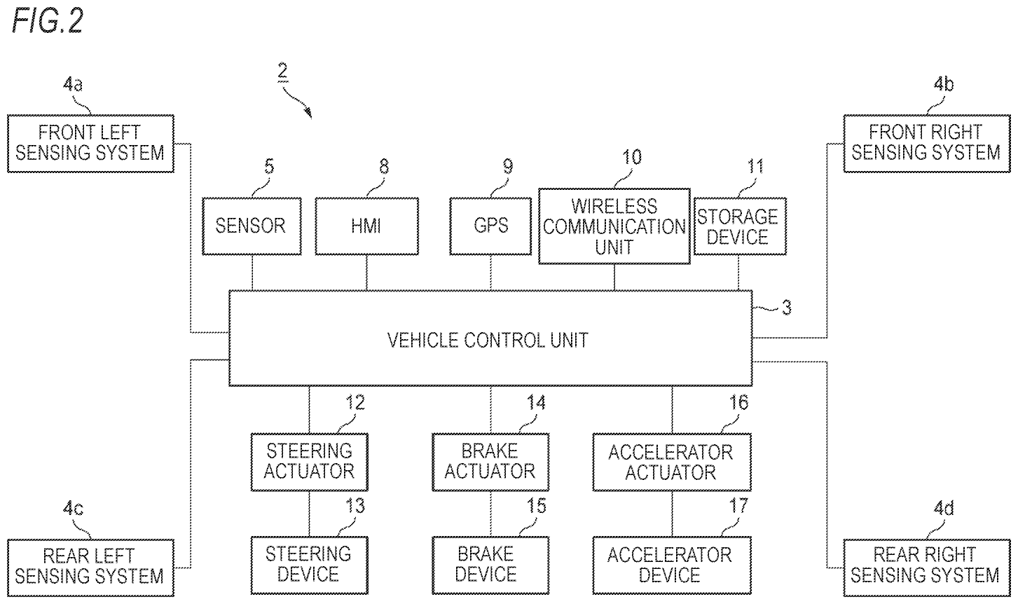

First, the vehicle 1 and a vehicle system 2 according to the embodiment will be described with reference to FIGS. 1 and 2. FIG. 1 is a schematic view illustrating a top view of the vehicle 1 including the vehicle system 2. FIG. 2 is a block diagram illustrating the vehicle system 2.

As illustrated in FIG. 1, the vehicle 1 is a vehicle (automobile) capable of traveling in an automatic driving mode. The vehicle 1 includes the vehicle system 2, a front left lamp 7a, a front right lamp 7b, a rear left lamp 7c, and a rear right lamp 7d.

As illustrated in FIGS. 1 and 2, the vehicle system 2 includes at least a vehicle control unit 3, a front left sensing system 4a (hereinafter, simply referred to as “sensing system 4a”), a front right sensing system 4b (hereinafter, simply referred to as “sensing system 4b”), a rear left sensing system 4c (hereinafter, simply referred to as “sensing system 4c”), and a rear right sensing system 4d (hereinafter, simply referred to as “sensing system 4d”).

Further, the vehicle system 2 includes a sensor 5, a Human Machine Interface (HMI) 8, a Global Positioning System (GPS) 9, a wireless communication unit 10, and a storage device 11. Further, the vehicle system 2 includes a steering actuator 12, a steering device 13, a brake actuator 14, a brake device 15, an accelerator actuator 16, and an accelerator device 17.

The vehicle control unit 3 is configured to control the traveling of the vehicle 1. The vehicle control unit 3 is composed of, for example, at least one Electronic Control Unit (ECU). The electronic control unit includes a computer system (for example, System on a Chip (SoC) or the like) including one or more processors and one or more memories, and an electronic circuit composed of active elements such as transistors and passive elements. The processor includes, for example, at least one of a Central Processing Unit (CPU), a Micro Processing Unit (MPU), a Graphics Processing Unit (GPU), and a Tensor Processing Unit (TPU). The CPU may be composed of a plurality of CPU cores. The GPU may be composed of a plurality of GPU cores. The memory includes a Read Only Memory (ROM) and a Random Access Memory (RAM). A vehicle control program may be stored in the ROM. For example, the vehicle control program may include an artificial intelligence (AI) program for autonomous driving. An AI program is a program (trained model) constructed by supervised or unsupervised machine learning (particularly deep learning) using a multi-layer neural network. The RAM may temporarily store a vehicle control program, vehicle control data, and/or surrounding environment information indicating surrounding environment of the vehicle. The processor may be configured to expand a program specified from various vehicle control programs stored in the ROM on the RAM and execute various processes in cooperation with the RAM. Further, the computer system may be configured by a non-von Neumann type computer such as an Application Specific Integrated Circuit (ASIC) or a Field-Programmable Gate Array (FPGA). Further, the computer system may be composed of a combination of a von Neumann type computer and a non-von Neumann type computer.

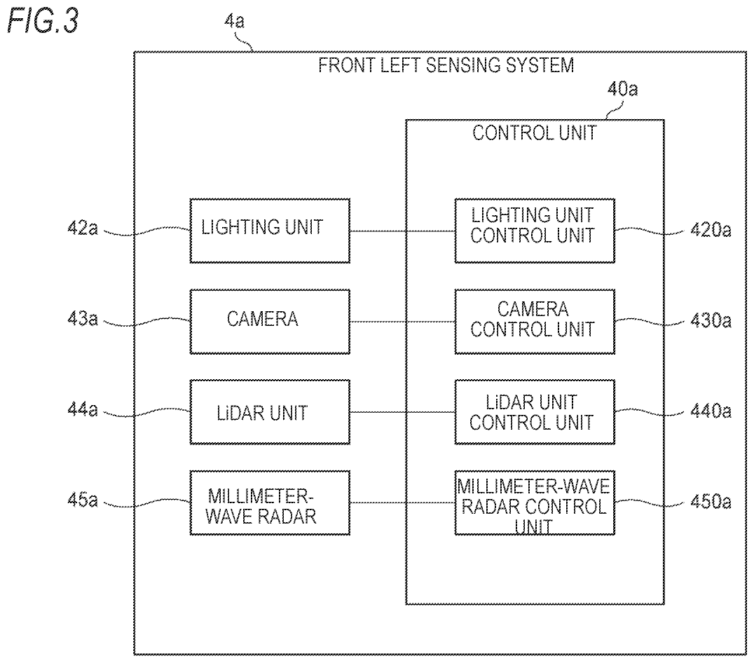

Each of the sensing systems 4a to 4d is configured to detect the surrounding environment of the vehicle 1. In the description of the embodiment, it is assumed that each of the sensing systems 4a to 4d includes the same component. Therefore, in the following, the sensing system 4a will be described with reference to FIG. 3. FIG. 3 is a block diagram illustrating the sensing system 4a.

As illustrated in FIG. 3, the sensing system 4a includes a control unit 40a, a lighting unit 42a, a camera 43a, a Light Detection and Ranging (LiDAR) unit 44a, and a millimeter-wave radar 45a. The control unit 40a, the lighting unit 42a, the camera 43a, the LiDAR unit 44a, and the millimeter-wave radar 45a are disposed in a space Sa formed by a housing 24a of the front left lamp 7a and a translucent outer cover 22a illustrated in FIG. 1. The control unit 40a may be disposed at a predetermined position of the vehicle 1 other than the space Sa. For example, the control unit 40a may be integrally configured with the vehicle control unit 3.

The control unit 40a is configured to control operations of the lighting unit 42a, the camera 43a, the LiDAR unit 44a, and the millimeter-wave radar 45a respectively. In this respect, the control unit 40a functions as a lighting unit control unit 420a, a camera control unit 430a, a LiDAR unit control unit 440a, and a millimeter-wave radar control unit 450a.

The control unit 40a is composed of at least one electronic control unit (ECU). The electronic control unit includes a computer system (for example, SoC and the like) including one or more processors and one or more memories, and an electronic circuit composed of active elements such as transistors and passive elements. The processor includes at least one of a CPU, an MPU, a GPU, and a TPU. The memory includes a ROM and a RAM. Further, the computer system may be composed of a non-von Neumann type computer such as an ASIC or an FPGA.

The lighting unit 42a is configured to form a light distribution pattern by emitting light toward the outside (front) of the vehicle 1. The lighting unit 42a has a light source which emits light and an optical system. The light source may be composed of, for example, a plurality of light emitting elements arranged in a matrix (for example, N rows×M columns, N>1, M>1). The light emitting element is, for example, a Light Emitting Diode (LED), a Laser Diode (LD), or an organic EL element. The optical system may include at least one of a reflector configured to reflect the light emitted from the light source toward the front of the lighting unit 42a, and a lens configured to refract the light emitted directly from the light source or the light reflected by the reflector.

The lighting unit control unit 420a is configured to control the lighting unit 42a so that the lighting unit 42a emits a predetermined light distribution pattern toward the front area of the vehicle 1. For example, the lighting unit control unit 420a may change the light distribution pattern emitted from the lighting unit 42a according to a driving mode of the vehicle 1.

The camera 43a is configured to detect the surrounding environment of the vehicle 1. In particular, the camera 43a is configured to acquire image data indicating the surrounding environment of the vehicle 1 and then transmit the image data to the camera control unit 430a. The camera control unit 430a may specify the surrounding environment information based on the transmitted image data. Here, the surrounding environment information may include information on an object existing outside the vehicle 1. For example, the surrounding environment information may include information on attributes of the object existing outside the vehicle 1, and information on the distance, direction, and/or position of the object with respect to the vehicle 1. The camera 43a includes, for example, an imaging element such as a Charge-Coupled Device (CCD) or a Complementary Metal Oxide Semiconductor (CMOS).

The LiDAR unit 44a is configured to detect the surrounding environment of the vehicle 1. In particular, the LiDAR unit 44a is configured to acquire point cloud data indicating the surrounding environment of the vehicle 1 and then transmit the point cloud data to the LiDAR unit control unit 440a. The LiDAR unit control unit 440a may specify the surrounding environment information based on the transmitted point cloud data.

More specifically, the LiDAR unit 44a acquires information on a flight time (TOF: Time of Flight) ΔT1 of a laser beam (optical pulse) at each emission angle (horizontal angle θ, vertical angle ϕ) of the laser beam. The LiDAR unit 44a can acquire information on a distance D between the LiDAR unit 44a and an object existing outside the vehicle 1 at each emission angle based on the information on the flight time ΔT1 at each emission angle.

The millimeter-wave radar 45a is configured to detect radar data indicating the surrounding environment of the vehicle 1. In particular, the millimeter-wave radar 45a is configured to acquire radar data and then transmit the radar data to the millimeter-wave radar control unit 450a. The millimeter-wave radar control unit 450a is configured to acquire surrounding environment information based on the radar data. The surrounding environment information may include information on an object existing outside the vehicle 1. The surrounding environment information may include, for example, information on the position and direction of the object with respect to the vehicle 1 and information on a relative velocity of the object with respect to the vehicle 1.

For example, the millimeter-wave radar 45a can acquire the distance and direction between the millimeter-wave radar 45a and an object existing outside the vehicle 1 by a pulse modulation method, a Frequency Modulated-Continuous Wave (FMCW) method, or a dual frequency CW method. When using the pulse modulation method, after acquiring information on a millimeter-wave flight time ΔT2, the millimeter-wave radar 45a can acquire information on the distance D between the millimeter-wave radar 45a and an object existing outside the vehicle 1 based on information on the flight time ΔT2. Also, the millimeter-wave radar 45a can acquire information on the direction of the object with respect to the vehicle 1 based on a phase difference between a phase of a millimeter wave (received wave) received by one receiving antenna and a phase of a millimeter wave (received wave) received by the other receiving antenna adjacent to one receiving antenna. Further, the millimeter-wave radar 45a can acquire information on a relative velocity V of the object with respect to the millimeter-wave radar 45a based on a frequency f0 of a transmitted wave radiated from a transmitting antenna and a frequency f1 of a received wave received by a receiving antenna. The specific structure of the millimeter-wave radar 45a will be described below.

Further, each of the sensing systems 4b to 4d is similarly provided with a control unit, a lighting unit, a camera, a LiDAR unit, and a millimeter-wave radar. In particular, these devices of the sensing system 4b are disposed in a space Sb formed by a housing 24b of the front right lamp 7b and a translucent outer cover 22b illustrated in FIG. 1. These devices of the sensing system 4c are disposed in a space Sc formed by a housing 24c of the rear left lamp 7c and a translucent outer cover 22c. These devices of the sensing system 4d are disposed in a space Sd formed by a housing 24d of the rear right lamp 7d and a translucent outer cover 22d.

Returning to FIG. 2, the sensor 5 may include an acceleration sensor, a velocity sensor, a gyro sensor, and the like. The sensor 5 is configured to detect the traveling state of the vehicle 1 and output traveling state information indicating the traveling state of the vehicle 1 to the vehicle control unit 3. Further, the sensor 5 may have an outside air temperature sensor which detects an outside air temperature outside the vehicle 1.

The HMI 8 includes an input unit which receives an input operation from a driver and an output unit which outputs traveling information and the like to the driver. The input unit includes a steering wheel, an accelerator pedal, a brake pedal, a driving mode changeover switch for switching a driving mode of the vehicle 1, and the like. The output unit is a display (for example, Head Up Display (HUD) or the like) which displays various traveling information. The GPS 9 is configured to acquire current position information of the vehicle 1 and output the acquired current position information to the vehicle control unit 3.

The wireless communication unit 10 is configured to receive information about another vehicle around the vehicle 1 from another vehicle and transmit information about the vehicle 1 to another vehicle (vehicle-to-vehicle communication). Further, the wireless communication unit 10 is configured to receive infrastructure information from infrastructure equipment such as traffic lights and indicator lights, and to transmit the traveling information of the vehicle 1 to the infrastructure equipment (road-to-vehicle communication). Further, the wireless communication unit 10 is configured to receive information about a pedestrian from a portable electronic device (smartphones, tablets, wearable devices, and the like) carried by the pedestrian, and to transmit the own vehicle traveling information of the vehicle 1 to the portable electronic device (pedestrian-to-vehicle communication). The vehicle 1 may directly communicate with another vehicle, infrastructure equipment, or a portable electronic device in an ad hoc mode, or may communicate via a communication network such as the Internet.

The storage device 11 is an external storage device such as a hard disk drive (HDD) or a Solid State Drive (SSD). The storage device 11 may store two-dimensional or three-dimensional map information and/or a vehicle control program. For example, the three-dimensional map information may be composed of 3D mapping data (point cloud data). The storage device 11 is configured to output map information and a vehicle control program to the vehicle control unit 3 in response to a request from the vehicle control unit 3. The map information and the vehicle control program may be updated via the wireless communication unit 10 and the communication network.

When the vehicle 1 travels in an automatic driving mode, the vehicle control unit 3 automatically generates at least one of a steering control signal, an accelerator control signal, and a brake control signal based on traveling state information, surrounding environment information, current position information, map information, and the like. The steering actuator 12 is configured to receive a steering control signal from the vehicle control unit 3 and control the steering device 13 based on the received steering control signal. The brake actuator 14 is configured to receive a brake control signal from the vehicle control unit 3 and control the brake device 15 based on the received brake control signal. The accelerator actuator 16 is configured to receive an accelerator control signal from the vehicle control unit 3 and control the accelerator device 17 based on the received accelerator control signal. In this way, the vehicle control unit 3 automatically controls the traveling of the vehicle 1 based on the traveling state information, the surrounding environment information, the current position information, the map information, and the like. That is, in the automatic driving mode, the traveling of the vehicle 1 is automatically controlled by the vehicle system 2.

On the other hand, when the vehicle 1 travels in a manual driving mode, the vehicle control unit 3 generates a steering control signal, an accelerator control signal, and a brake control signal according to a manual operation of the driver with respect to the accelerator pedal, the brake pedal, and the steering wheel. As described above, in the manual driving mode, the steering control signal, the accelerator control signal, and the brake control signal are generated by the manual operation of the driver, so that the traveling of the vehicle 1 is controlled by the driver.

(Millimeter-Wave Radar Configuration)

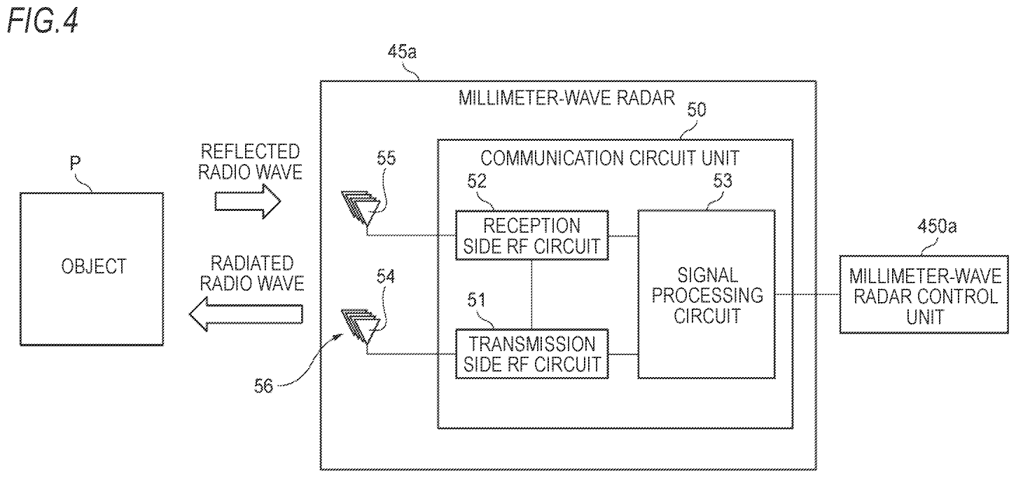

Next, a configuration of the millimeter-wave radar 45a (an example of the radio wave transmission and reception module) will be described in detail with reference to FIG. 4. In the embodiment, it is assumed that the configuration of the millimeter-wave radar of the sensing systems 4b to 4d is the same as the configuration of the millimeter-wave radar 45a of the sensing system 4a. FIG. 4 is a block diagram illustrating the configuration of the millimeter-wave radar 45a.

As illustrated in FIG. 4, the millimeter-wave radar 45a includes an antenna unit 56 and a communication circuit unit 50. The antenna unit 56 includes a plurality of transmitting antennas 54 configured to radiate millimeter waves, which are radio waves having a wavelength of 1 mm to 10 mm, and a plurality of receiving antennas 55 configured to receive millimeter waves. In this respect, the radiated radio wave radiated from the transmitting antenna 54 is reflected by an object P, and then the reflected radio wave from the object P is received by the receiving antenna 55.

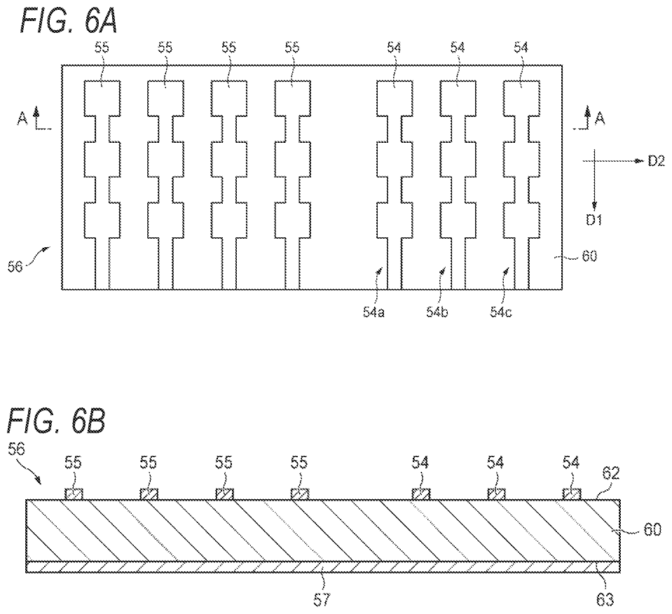

Further, as illustrated in FIGS. 6A and 6B, the transmitting antenna 54 may be configured as, for example, a patch antenna. In this example, each of the nine transmitting antennas 54 is configured as a patch antenna (metal pattern) made of a conductive material. In this respect, three transmitting antennas 54 are arranged in a D1 direction (column direction) and three transmitting antennas 54 are arranged in a D2 direction (row direction). By arranging a plurality of transmitting antennas 54 in the D1 direction, it is possible to improve the directivity of the transmitting antennas 54 in the D1 direction. Similarly, by arranging a plurality of transmitting antennas 54 in the D2 direction, it is possible to improve the directivity of the transmitting antennas 54 in the D2 direction.

Further, when respective transmitting antenna groups including three transmitting antennas 54 are respectively set as 54a, 54b, and 54c, by adjusting a phase of a high frequency signal supplied to the three transmitting antenna groups 54a, 54b, and 54c arranged in the D2 direction, it is possible to control a beam direction of a synthetic radio wave in which each radiated radio wave is combined. In this way, the beam direction of the synthetic radio wave can be changed without mechanically rotating the antenna unit 56.

Further, the receiving antenna 55 may also be configured as a patch antenna in the same manner. In this example, each of the twelve receiving antennas 55 is configured as a patch antenna made of a conductive material. In this respect, three receiving antennas 55 are arranged in the D1 direction and four receiving antennas 55 are arranged in the D2 direction. In this way, the directivity of the receiving antennas 55 in the D1 direction and the D2 direction can be improved.

The antenna unit 56 further includes an insulating substrate 60 made of an insulating material and a ground electrode 57. The transmitting antenna 54 and the receiving antenna 55 are formed on an upper surface 62 of the insulating substrate 60 as patch antennas and the ground electrode 57 is formed on a lower surface 63 of the insulating substrate 60. As described above, the antenna unit 56 is configured as an antenna substrate including a receiving antenna and a transmitting antenna.

Returning to FIG. 4, the communication circuit unit 50 includes a transmission side RF (radio frequency) circuit 51, a reception side RF circuit 52, and a signal processing circuit 53. The communication circuit unit 50 is configured as a monolithic microwave integrated circuit (MMIC). The transmission side RF circuit 51 is electrically connected to each transmitting antenna 54. The reception side RF circuit 52 is electrically connected to each receiving antenna 55. The signal processing circuit 53 is configured to control the transmission side RF circuit 51 and the reception side RF circuit 52 in response to a control signal from the millimeter-wave radar control unit 450a. Further, the signal processing circuit 53 is configured to generate radar data by processing the digital signal output from the reception side RF circuit 52 and then transmit the generated radar data to the millimeter-wave radar control unit 450a. The signal processing circuit 53 includes, for example, a Digital Signal Processor (DSP) configured to process a digital signal transmitted from the reception side RF circuit 52 and a microcomputer composed of a processor and a memory.

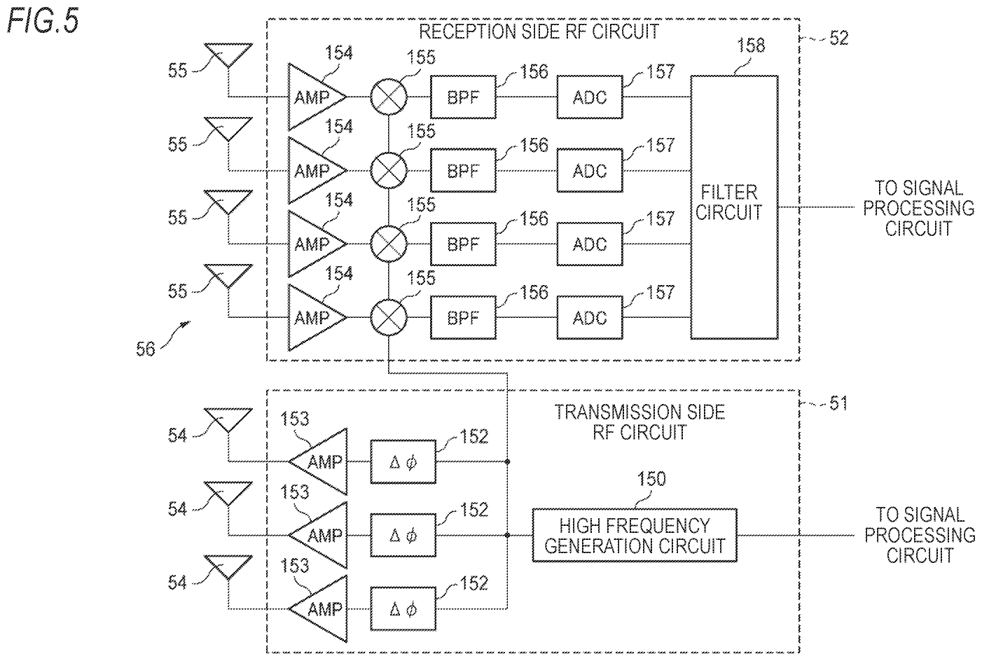

Next, the transmission side RF circuit 51 and the reception side RF circuit 52 will be described in detail with reference to FIG. 5. FIG. 5 is a diagram illustrating a configuration of the transmission side RF circuit 51 and the reception side RF circuit 52. As illustrated in FIG. 5, the transmission side RF circuit 51 includes a high frequency generation circuit 150, a phase device 152, and an amplifier 153. The high frequency generation circuit 150 is configured to generate a high frequency signal. In this respect, when the millimeter-wave radar 45a is a millimeter-wave radar which adopts the FMCW method, the high frequency generation circuit 150 generates a chirp signal (FMCW signal) whose frequency changes linearly with the passage of time.

Each of the phase devices 152 is configured to adjust the phase of the high frequency signal output from the high frequency generation circuit 150. In this way, by adjusting the phase of the high frequency signal by each phase device 152, it is possible to change the beam direction in a horizontal direction of the synthetic radio wave of the radiated radio wave radiated from the plurality of transmitting antennas 54. In this respect, the beam direction in the horizontal direction of the synthetic radio wave can be changed in response to a phase difference between a high frequency signal which passes through an upper phase device 152 and a high frequency signal which passes through a middle phase device 152, and a phase difference between the high frequency signal which passes through the middle phase device 152 and a high frequency signal which passes through a lower phase device 152. On the other hand, when each phase device 152 does not adjust the phase of the high frequency signal, the beam direction of the synthetic radio wave of the radiated radio wave does not change. Further, when the millimeter-wave radar 45a is not a phased array radar, the transmission side RF circuit 51 may not be provided with the phase device 152.

The amplifier 153 is configured to amplify the high frequency signal which passes through the phase device 152. In this way, the high frequency signal amplified by the amplifier 153 is supplied to each transmitting antenna 54, so that each transmitting antenna 54 radiates radio waves (millimeter waves) corresponding to the high frequency signal into the air.

The reception side RF circuit 52 includes an amplifier 154, a mixer 155, a bandpass filter (BPF) 156, an AD converter 157, and a filter circuit 158. The amplifier 154 is configured to amplify the high frequency signal output from the receiving antenna 55. In particular, the receiving antenna 55 receives the reflected radio wave reflected by the object, and then converts the received reflected radio wave into a high frequency signal. Next, the amplifier 154 amplifies the weak high frequency signal output by the receiving antenna 55. The mixer 155 generates an intermediate frequency (IF) signal (also called a beat frequency signal) by mixing the high frequency signal (RX signal) output from the amplifier 154 and the high frequency signal (TX signal) from the high frequency generation circuit 150. Then, the IF signal (analog signal) which passes through the BPF 156 is converted from an analog signal to a digital signal by the AD converter 157. The digital signal is transmitted to the signal processing circuit 53 via the filter circuit 158. The signal processing circuit 53 generates radar data indicating the position and relative velocity of the object by performing a fast Fourier transform (FFT) on the digital signal (IF signal).

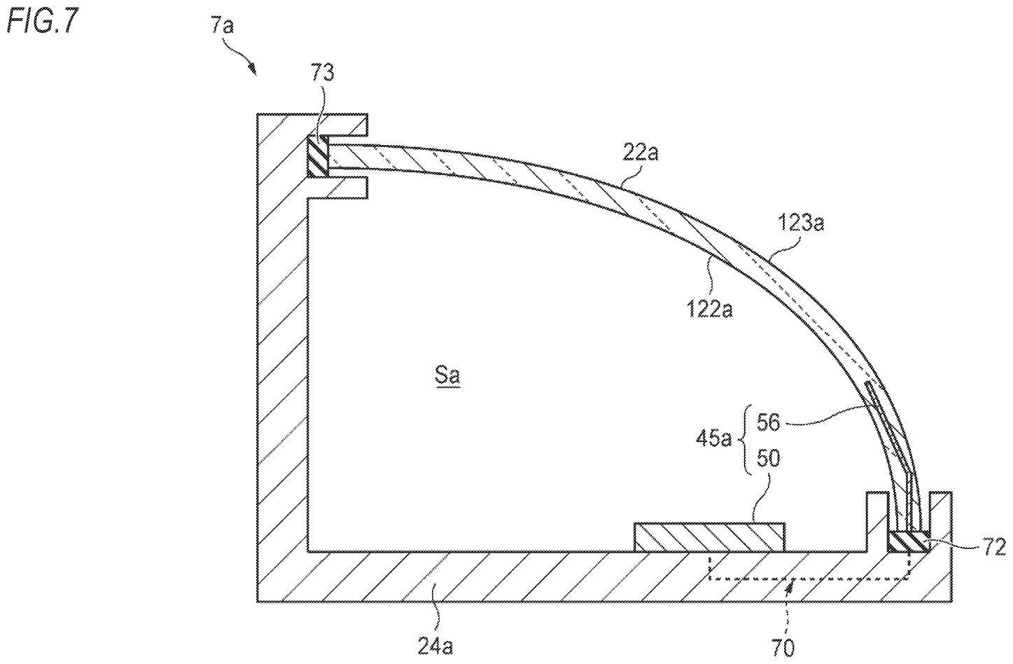

Next, the millimeter-wave radar 45a mounted on the front left lamp 7a will be described below with reference to FIG. 7. FIG. 7 is a vertical cross-sectional view illustrating the front left lamp 7a on which the millimeter-wave radar 45a is mounted. In this figure, for convenience of explanation, the illustration of devices (for example, lighting unit 42a and the like) other than the millimeter-wave radar 45a is omitted. As illustrated in FIG. 7, the space Sa is formed by the housing 24a and the outer cover 22a covering an opening portion of the housing 24a. One end of the outer cover 22a is fixed to the housing 24a via a metal fixing member 73 and the other end of the outer cover 22a is fixed to the housing 24a via a metal fixing member 72. The metal fixing members 72 and 73 are, for example, screws, rivets, or springs.

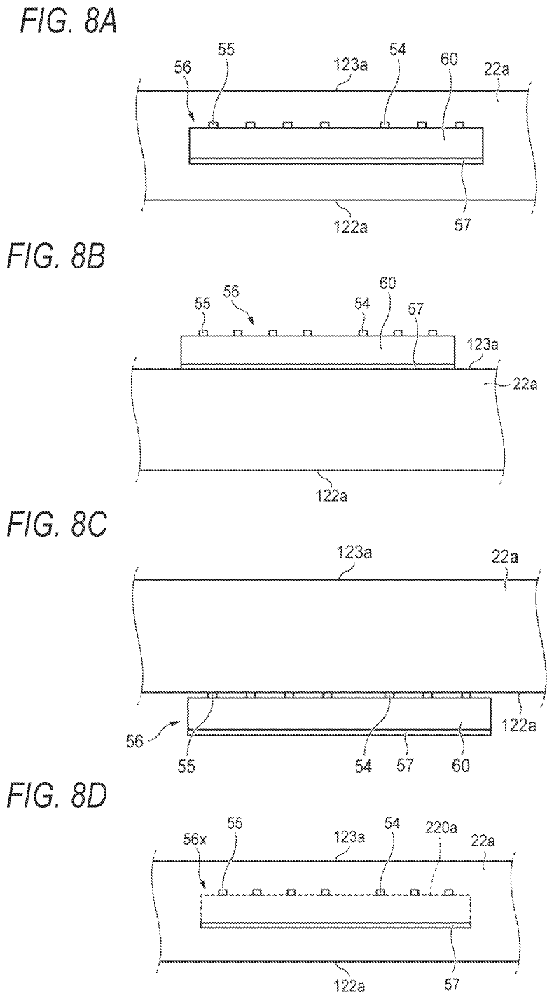

The communication circuit unit 50 of the millimeter-wave radar 45a is disposed in the space Sa. In this respect, the communication circuit unit 50 is disposed on the surface of the housing 24a in the space Sa. The antenna unit 56 of the millimeter-wave radar 45a is provided inside the outer cover 22a. In particular, as illustrated in FIG. 8A, in the antenna unit 56, the antenna unit 56 is provided inside the outer cover 22a so that the transmitting antenna 54 and the receiving antenna 55 face an outer surface 123a of the outer cover 22a, while the ground electrode 57 faces an inner surface 122a of the outer cover 22a. In this case, the transmitting antenna 54 can efficiently radiate the radiated radio wave toward the outside of the vehicle 1 and the receiving antenna 55 can efficiently receive the reflected radio wave. As described above, in the embodiment, the communication circuit unit 50 and the antenna unit 56 are mounted on the front left lamp 7a in a state of being separated from each other. Further, the antenna unit 56 is electrically connected to the communication circuit unit 50 via the metal fixing member 72 and a cable 70.

As described above, according to the embodiment, the antenna unit 56 is provided inside the outer cover 22a, while the communication circuit unit 50 is disposed in the space Sa. Therefore, the millimeter-wave radar 45a can be successfully mounted on the front left lamp 7a without reducing an external size of the antenna unit 56 and/or the communication circuit unit 50 of the millimeter-wave radar 45a.

Further, according to the embodiment, the antenna unit 56 and the communication circuit unit 50 can be electrically connected by using the metal fixing member 72 which fixes the outer cover 22a and the housing 24a.

In the embodiment, the antenna unit 56 is provided inside the outer cover 22a, but the embodiment is not limited to this. For example, as illustrated in FIG. 8B, the antenna unit 56 may be disposed on the outer surface 123a of the outer cover 22a. Further, as illustrated in FIG. 8C, the antenna unit 56 may be disposed on the inner surface 122a of the outer cover 22a. Further, as illustrated in FIG. 8D, the insulating substrate 60 forming the antenna unit 56 may be replaced with a part 220a of the outer cover 22a. In this case, an antenna unit 56x according to a modification example includes the transmitting antenna 54, the receiving antenna 55, the part 220a of the outer cover 22a, and the ground electrode 57 facing the transmitting antenna 54 and the receiving antenna 55 via the part 220a.

### Second Embodiment

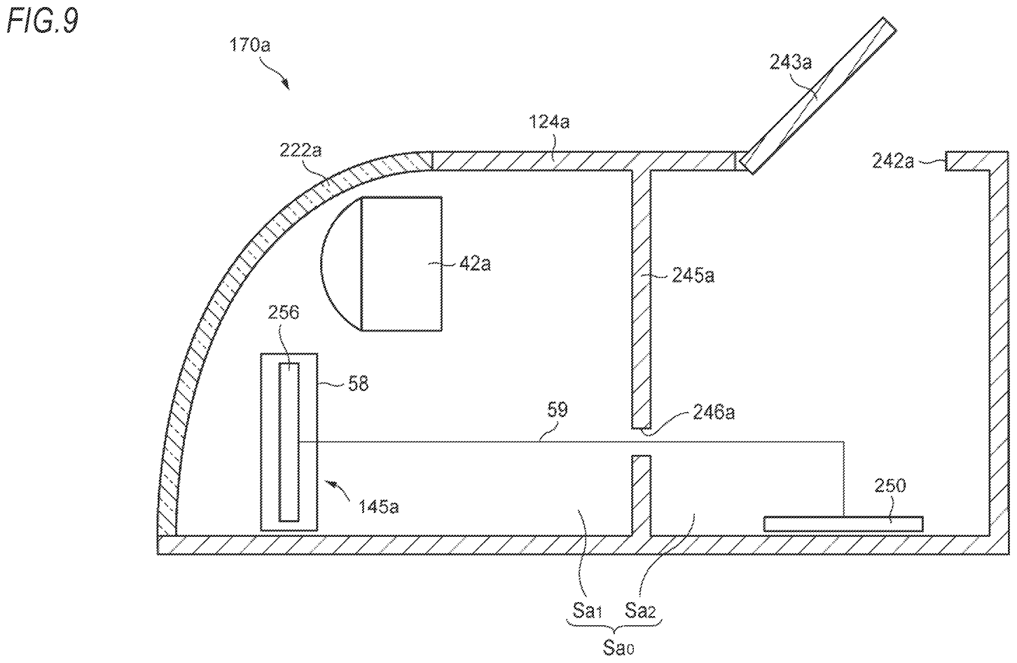

Next, a front left lamp 170a according to a second embodiment will be described below. In particular, a millimeter-wave radar 145a mounted on a front left lamp 170a will be described below with reference to FIG. 9. FIG. 9 is a vertical cross-sectional view illustrating the front left lamp 170a on which the millimeter-wave radar 145a is mounted. In this figure, for convenience of explanation, the illustration of devices (for example, camera, LiDAR unit, and the like) other than the millimeter-wave radar 145a and the lighting unit 42a is omitted.

Further, the millimeter-wave radar 145a of the embodiment has the same configuration as that of the millimeter-wave radar 45a of the first embodiment. In particular, the antenna unit 256 of the millimeter-wave radar 145a has the same configuration as that of the antenna unit 56 of the first embodiment. A communication circuit unit 250 of the millimeter-wave radar 145a has the same configuration as that of the communication circuit unit 50 of the first embodiment.

As illustrated in FIG. 9, a space Sao is formed by a housing 124a of the front left lamp 170a and an outer cover 222a covering an opening portion of the housing 124a. The front left lamp 170a is provided with a plate-shaped partition member 245a. The partition member 245a is configured to partition the space Sao into a first space Sₐ₁ and a second space Sₐ₂.

The antenna unit 256 of the millimeter-wave radar 145a and the lighting unit 42a are disposed in the first space Sₐ₁. In particular, the antenna unit 256 is disposed in the first space Sₐ₁ so that the transmitting antenna and the receiving antenna face the outer cover 222a. In this case, the transmitting antenna can efficiently radiate the radiated radio wave to the outside of the vehicle 1 and the receiving antenna can efficiently receive the reflected radio wave. Further, the antenna unit 256 is packed by a radome 58. Although the camera and LiDAR unit are not illustrated in this figure, it is assumed that the camera and LiDAR unit are also disposed in the first space Sₐ₁.

The communication circuit unit 250 of the millimeter-wave radar 145a is disposed in the second space Sₐ₂. Further, the communication circuit unit 250 is electrically connected to the antenna unit 256 via an electric cable 59. In this respect, the partition member 245a is provided with an opening portion 246a which allows the passage of the electric cable 59. The electric cable 59 may be, for example, a coaxial cable.

Further, the housing 124a is provided with an opening portion 242a which communicates with an external space and the second space Sₐ₂, and a lid portion 243a which is configured to close the opening portion 242a. The lid 243a is closed during normal use of the front left lamp 170a. On the other hand, when there is an abnormality in the millimeter-wave radar 145a (particularly, the communication circuit unit 250), an operator can quickly take out the communication circuit unit 250 disposed in the second space Sₐ₂ from the front left lamp 170a by opening the lid portion 243a. In this way, the lid portion 243a improves the handleability of the millimeter-wave radar 145a.

As described above, according to the embodiment, the antenna unit 256 of the millimeter-wave radar 145a and the communication circuit unit 250 are disposed in the space Sₐ₀ in a state of being physically separated from each other. Therefore, it is possible to successfully mount the millimeter-wave radar 145a on the front left lamp 170a without downsizing the millimeter-wave radar 145a. Further, the antenna unit 256 and the lighting unit 42a are disposed in the first space Sₐ₁, while the communication circuit unit 250 is disposed in the second space Sₐ₂. Therefore, it is possible to preferably prevent the communication circuit unit 250 from being adversely affected by heat generated from the lighting unit 42a.

In this embodiment, the antenna unit 256 may not be packed by the radome 58. In this case, the antenna unit 256 may be transparent to visible light. Specifically, an insulating substrate may be, for example, a glass substrate which is transparent to visible light. The transmitting antenna and the receiving antenna may be configured as, for example, a patch antenna made of a transparent conductive material. As the transparent conductive material, for example, ITO (indium, tin oxide) which is a transparent conductive film may be used.

In this way, since the antenna unit 256 is transparent to visible light, it becomes difficult for the antenna unit 256 to be visually recognized from the outside of the vehicle 1. As a result, the design properties of the front left lamp 170a on which the millimeter-wave radar 145a is mounted can be improved.

### First Modification Example

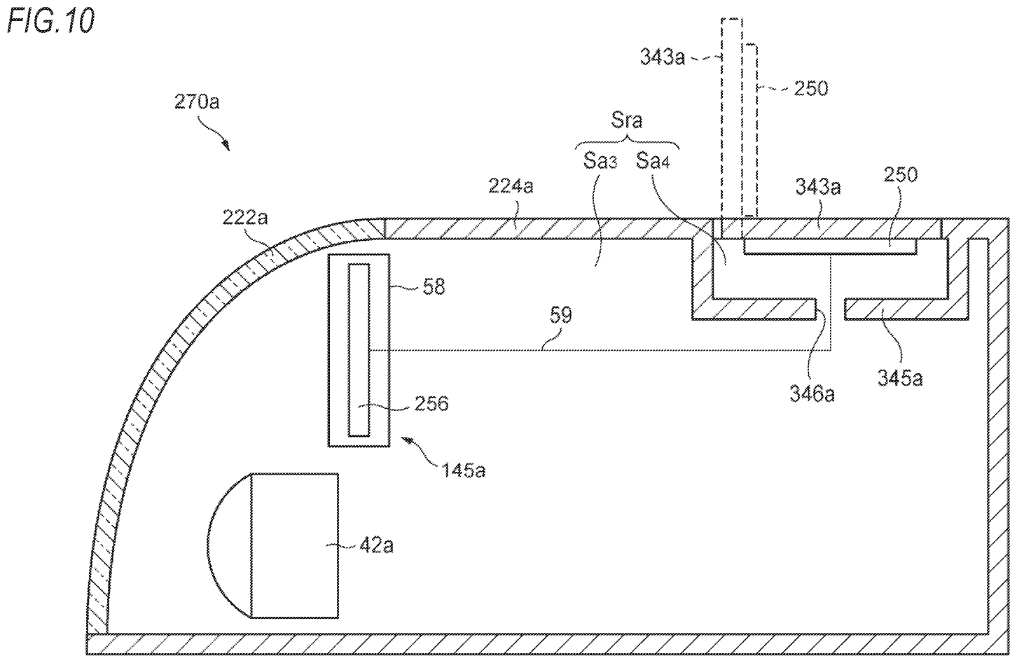

Next, a front left lamp 270a according to a first modification example of the second embodiment will be described below with reference to FIG. 10. FIG. 10 is a vertical cross-sectional view illustrating the front left lamp 270a according to a first modification example on which the millimeter-wave radar 145a is mounted. The front left lamp 270a illustrated in FIG. 10 and the front left lamp 170a illustrated in FIG. 9 differ from each other mainly in the configuration of the partition member. As illustrated in FIG. 10, a space Sᵣₐ is formed by a housing 224a and the outer cover 222a covering an opening portion of the housing 224a. The front left lamp 270a is provided with a partition member 345a surrounding the communication circuit unit 250. The partition member 345a is configured to partition the space Sᵣₐ into a first space Sₐ₃ and a second space Sₐ₄.

The antenna unit 256 and the lighting unit 42a are disposed in the first space Sₐ₃. In particular, the antenna unit 256 is disposed in the first space Sₐ₃ so that the transmitting antenna and the receiving antenna face the outer cover 222a. Similarly, in this figure, the camera and the LiDAR unit are not illustrated, but it is assumed that the camera and the LiDAR unit are also disposed in the first space Sₐ₃.

The communication circuit unit 250 is disposed in the second space Sₐ₄. In particular, the communication circuit unit 250 is disposed on a lid portion 343a provided on the housing 224a. Further, the communication circuit unit 250 is electrically connected to the antenna unit 256 via the electric cable 59. In this respect, the partition member 345a is provided with an opening portion 346a which allows the passage of the electric cable 59.

According to this modification example, the antenna unit 256 and the communication circuit unit 250 are disposed in the space Sᵣₐ in a state of being physically separated from each other. Therefore, it is possible to successfully mount the millimeter-wave radar 145a on the front left lamp 270a without downsizing the millimeter-wave radar 145a. Further, the antenna unit 256 and the lighting unit 42a are disposed in the first space Sₐ₃, while the communication circuit unit 250 is disposed in the second space Sₐ₄. Therefore, it is possible to preferably prevent the communication circuit unit 250 from being adversely affected by the heat generated from the lighting unit 42a.

Further, according to this modification example, when there is an abnormality in the millimeter-wave radar 145a (particularly, the communication circuit unit 250), an operator can easily take out the communication circuit unit 250 disposed on the lid portion 343a from the front left lamp 270a by opening the lid portion 343a. In this way, by disposing the communication circuit unit 250 on the lid portion 343a, the handleability of the millimeter-wave radar 145a mounted on the front left lamp 270a is further improved.

Similarly, in this modification example, the antenna unit 256 may not be packed by the radome 58. In this case, the antenna unit 256 may be transparent to visible light.

### Second Modification Example

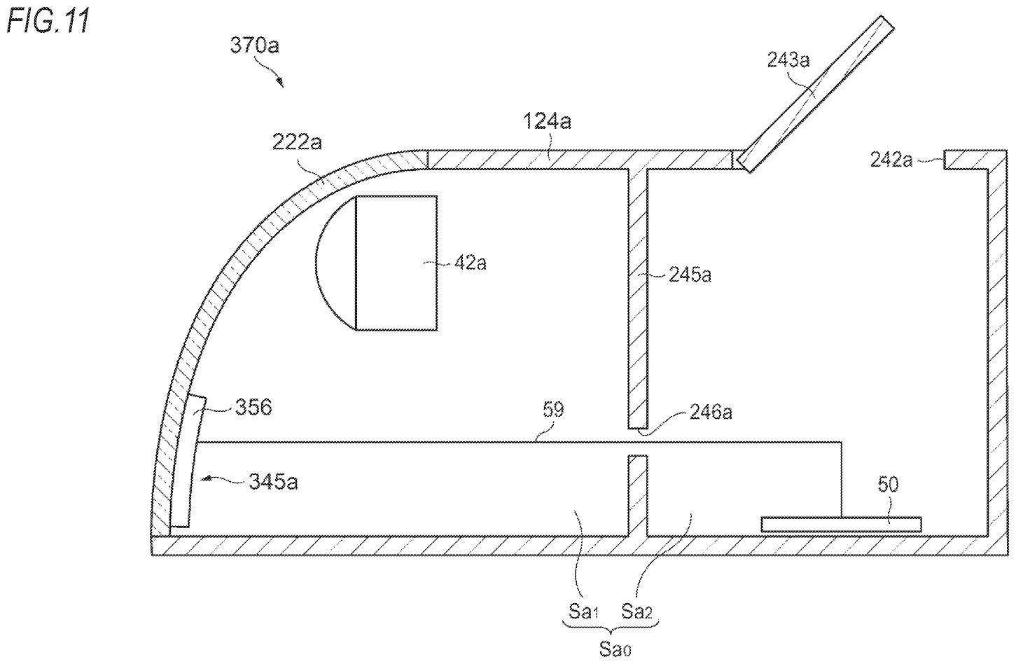

Next, a front left lamp 370 according to a second modification example of the second embodiment will be described below with reference to FIG. 11. FIG. 11 is a vertical cross-sectional view illustrating a front left lamp 370a according to the second modification example on which the millimeter-wave radar 345a is mounted. The front left lamp 370a illustrated in FIG. 11 differs from the front left lamp 170a illustrated in FIG. 9 in that an antenna unit 356 of the millimeter-wave radar 345a has a different configuration. In the following, only the configuration of the antenna unit 356 will be described.

The antenna unit 356 is not packed by the radome and is attached to the outer cover 222a. Further, the antenna unit 356 is transparent to visible light and has flexibility.

Specifically, the insulating substrate of the antenna unit 356 may be a flexible substrate made of a material transparent to visible light. The transmitting antenna and the receiving antenna of the antenna unit 356 may be configured as, for example, a patch antenna made of a transparent conductive material. As the transparent conductive material, for example, ITO may be used. Further, the insulating substrate of the antenna unit 356 may be provided with an adhesive layer in contact with the outer cover 222a.

As described above, according to this modification example, since the antenna unit 356 is attached to the outer cover 222a, it is not necessary to secure a space for disposing the antenna unit 356 in the first space Sₐ₁. In this way, the degree of freedom in designing the front left lamp 370a can be improved and the millimeter-wave radar 345a can be successfully mounted in the front left lamp 370a without downsizing the millimeter-wave radar 345a. Furthermore, since the antenna unit 356 is transparent to visible light, it becomes difficult for the antenna unit 356 to be visually recognized from the outside of the vehicle 1, and thus the design properties of the front left lamp 370a on which the millimeter-wave radar 345a is mounted can be improved.

Although the embodiments of the invention are described above, it goes without saying that the technical scope of the invention should not be construed as being limited by the description of the embodiments. It will be appreciated by those skilled in the art that the embodiments are merely an example and that various embodiments can be modified within the scope of the invention described in the claims. The technical scope of the invention should be determined based on the scope of the invention described in the claims and the equivalent scope thereof.

In the first and second embodiments, the millimeter-wave radar 45a is described as an example of the radio wave transmission and reception module, but the radio wave transmission and reception module is not limited to the millimeter-wave radar. For example, the radio wave transmission and reception module may be a wireless communication module (wireless communication unit 10) configured to wirelessly communicate with an external device. In particular, the wireless communication module may be a wireless communication module for a fifth generation (5G) mobile communication system. In this case, an antenna unit of the wireless communication module is provided on the outer cover 22a of the front left lamp 7a. Further, the communication circuit unit of the wireless communication module is disposed in the space Sa of the front left lamp 7a. The configuration of the communication circuit unit and the antenna unit of the wireless communication module may be different from the configuration of the communication circuit unit and the antenna unit of the millimeter-wave radar.

Further, in the second embodiment and its modification example, the communication circuit unit 250 is disposed in the space Sₐ₀ (particularly, the second space) of the front left lamp 170a, but the second embodiment is not limited to this. For example, the communication circuit unit 250 may be disposed outside the space Sₐ₀. For example, the communication circuit unit 250 may be disposed outside the space Sa and on an outer surface of the housing 124a. In this case as well, it is possible to preferably prevent the communication circuit unit 250 from being adversely affected by the heat generated from the lighting unit 42a.

This application appropriately incorporates the contents disclosed in the Japanese patent application (Japanese Patent Application No. 2019-040703) filed on Mar. 6, 2019, the contents disclosed in the Japanese patent application (Japanese Patent Application No. 2019-040704) filed on Mar. 6, 2019, and the contents disclosed in the Japanese patent application (Japanese Patent Application No. 2020-022494) filed on Feb. 13, 2020.

### REFERENCE SIGNS LIST

1: vehicle
2: vehicle system
3: vehicle control unit
4a: front left sensing system
4b: front right sensing system
4c: rear left sensing system
4d: rear right sensing system
5: sensor
7a, 170a, 270a, 370a: front left lamp
7b: front right lamp
7c: rear left lamp
7d: rear right lamp
10: wireless communication unit
11: storage device
12: steering actuator
13: steering device
14: brake actuator
15: brake device
16: accelerator actuator
17: accelerator device
22a, 22b, 22c, 22d, 222a: outer cover
24a, 24b, 24c, 24d, 124a: housing
40a: control unit
42a: lighting unit
43a: camera
44a: LiDAR unit
45a, 145a, 345a: millimeter-wave radar
50, 250: communication circuit unit
51: transmission side RF circuit
52: reception side RF circuit
53: signal processing circuit
54: transmitting antenna
55: receiving antenna
56, 56x, 256, 356: antenna unit
57: ground electrode
58: radome
59: electric cable
60: insulating substrate
70: cable
72, 73: metal fixing member
150: high frequency generation circuit
152: phase device
153, 154: amplifier
155: mixer
156: BPF
157: AD converter
158: filter circuit
420a: lighting unit control unit
430a: camera control unit
440a: LiDAR unit control unit
450a: millimeter-wave radar control unit

1. A vehicular lamp comprising:
a housing;
an outer cover covering an opening of the housing; and
a radio wave transmission and reception module,
wherein the radio wave transmission and reception module includes:
an antenna unit including a transmitting antenna and a receiving antenna; and
a communication circuit unit including,
a transmission side RF circuit electrically connected to the transmitting antenna,
a reception side RF circuit electrically connected to the receiving antenna, and
a signal processing circuit configured to process a digital signal output from the reception side RF circuit,
wherein
the antenna unit is provided on the outer cover, and
the communication circuit unit is disposed in a space formed by the housing and the outer cover.

2. The vehicular lamp according to claim 1, wherein
the antenna unit is provided inside the outer cover.

3. The vehicular lamp according to claim 1, wherein
the antenna unit is provided on a surface of the outer cover.

4. The vehicular lamp according to claim 1, wherein
the antenna unit and the communication circuit unit are electrically connected to each other via a metal fixing member which fixes the outer cover and the housing.

5. The vehicular lamp according to claim 1, wherein
the radio wave transmission and reception module is a millimeter-wave radar configured to acquire data indicating surrounding environment of a vehicle.

6. The vehicular lamp according to claim 1, wherein
the radio wave transmission and reception module is a wireless communication module configured to wirelessly communicate with an external device.

7. A vehicular lamp which is mounted on a vehicle, comprising:
a housing;
an outer cover covering an opening of the housing;
a lighting unit disposed in a space formed by the housing and the outer cover; and
a millimeter-wave radar configured to acquire data indicating surrounding environment of the vehicle,
wherein the millimeter-wave radar includes:
an antenna unit including a transmitting antenna and a receiving antenna; and
a communication circuit unit including,
a transmission side RF circuit electrically connected to the transmitting antenna,
a reception side RF circuit electrically connected to the receiving antenna, and
a signal processing circuit configured to process a digital signal output from the reception side RF circuit,
wherein
the antenna unit and the communication circuit unit are physically separated from each other, and
the antenna unit is disposed in the space.

8. The vehicular lamp according to claim 7, further comprising:
a partition member configured to partition the space into a first space and a second space,
wherein
the antenna unit and the lighting unit are disposed in the first space, and
the communication circuit unit is disposed in the second space.

9. The vehicular lamp according to claim 7, wherein
the housing has an opening portion and a lid portion configured to close the opening portion, and
the communication circuit unit is disposed on the lid portion.

10. The vehicular lamp according to claim 7, wherein
the communication circuit unit is disposed outside the space.

11. The vehicular lamp according to claim 7, wherein
the antenna unit is attached to the outer cover.

12. The vehicular lamp according to claim 7, wherein
the antenna unit is transparent to visible light.

13. A vehicle which includes the vehicular lamp according to claim 1.
